(19) United States
(12) Patent Application Publication
(10) Pub. No.: US 2022/0098382 A1
(43) Pub. Date: Mar. 31, 2022

(54) ENERGY ABSORBING FOAM MATERIAL AND METHOD OF USING THEREOF

(71) Applicant: Nano and Advanced Materials Institute Limited, Hong Kong (HK)

(72) Inventors: Yong ZHU, Hong Kong (HK); Jianping HAN, Hong Kong (HK); Chenmin LIU, Hong Kong (HK)

(21) Appl. No.: 17/460,330

(22) Filed: Aug. 30, 2021

Related U.S. Application Data
(60) Provisional application No. 63/084,589, filed on Sep. 29, 2020.

(51) Int. Cl. C08J 9/12; C08G 18/76

(52) U.S. Cl. CPC C08J 9/125; C08G 18/7671; C08J 2375/04; C08J 2203/10; C08G 2110/0083

(57) ABSTRACT

The present invention provides an energy absorbing foam material includes at least one shape memory polymer foam having a non-impact resistant configuration in a first force-application time, an impact resistant configuration in a second force-application time at a working temperature, a first glass transition temperature equal to or lower than a working temperature in the first force-application time, and a second glass transition temperature higher than a working temperature in the second force-application time. A second elastic modulus of the shape memory polymer foam in the second force-application time is at least 10 times than a first elastic modulus of the shape memory polymer form in the first force-application time at the working temperature.

### CROSS-REFERENCE TO RELATED APPLICATION

This application claims priority from U.S. provisional patent application No. 63/084,589 filed on Sep. 29, 2020, the disclosures of which are incorporated herein by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present invention provides an energy absorbing foam material and method of using thereof. More specifically, the energy absorbing foam material is in a non-impact resistant configuration in a long force application time, in an impact resistant configuration in a short force application time, a first glass transition temperature equal to or lower than a working temperature in the first force-application time, and a second glass transition temperature higher than a working temperature in the second force-application time.

### BACKGROUND

In our daily life, people might get injured in dangerous work environments (building site or fire scene), unavoidable natural disasters (earthquake or tsunami) and in some intense exercises (football or car racing). Traditionally, many materials, for example, metals, ceramics and composites, have been used to absorb the impact energy and maintain the structure integrity so as to prevent injury. However, these materials are usually heavy, rigid and inflexible, which would limit the applications in the modern society. Recently, shear thickening fluid or shear thickening polymer, a kind of non-Newtonian material, have attracted great attention for their practical applications as an impact resistant material. As for shear thickening fluid, they are usually concentrated colloidal suspensions composed of non-aggregating particles suspended in fluids. The viscosity would increase sharply once the external shear stress is beyond a critical shear rate. As for shear thickening polymer, it presents as a soft polymer viscoelastic material in normal condition. Furthermore, the storage modulus increases dramatically once it is rapidly hit by an external shear stress. However, both of these materials have distinct drawbacks, such as stability, leakage and seal problem. The leakage and seal problem would lead to complex manufacturing process and higher cost. In addition, due to the higher density of these materials, the products comprised of these materials are usually too heavy which limit the transportation and their applications.

Therefore, in view of the above disadvantages, there is a need to provide an energy absorbing material which is light-weighted, flexible, self-supported, cost effective, and impact resistant in a short force application time.

### SUMMARY OF THE INVENTION

In view of the foregoing problem, this disclosure provides an energy absorbing foam material and method of using thereof.

Accordingly, one aspect of the present invention provides an energy absorbing foam material includes at least one shape memory polymer foam. The shape memory polymer foam includes a non-impact resistant configuration in a first force-application time, and an impact resistant configuration in a second force-application time at a working temperature. Meanwhile, the shape memory polymer foam has a first glass transition temperature equal to or lower than a working temperature in the first force-application time, and a second glass transition temperature higher than a working temperature in the second force-application time. The non-impact resistant configuration comprises a deformed configuration and an original configuration. A second elastic modulus of the shape memory polymer foam in the second force-application time is at least 10 times than a first elastic modulus of the shape memory polymer form in the first force-application time at the working temperature. The first force-application time is approximately from 0.1 second to 1000 seconds and the second force-application time is approximately below 0.1 second.

In one embodiment of the present invention, the the shape memory polymer foam is selected from one or more of polyurethane foam, polystyrene foam, silicone rubber foam, polyvinyl chloride foam, ethylene-vinyl acetate foam, and polyester block co-polymer foam.

In one embodiment of the present invention, the working temperature is approximately from 15° C. to 55° C.

In one embodiment of the present invention, the yield point of the shape memory foam is approximately from 0.5 kPa to 1 MPa.

In one embodiment of the present invention, the shape memory polymer foam is polyurethane foam.

In one embodiment of the present invention, it provides an impact-resistant article comprising the energy absorbing foam material of the present invention.

In one aspect of the present invention, it also provides a method of molding the energy absorbing foam, which includes (1) providing the energy absorbing foam material having an original shape; (2) at a force-application time less than approximately 0.1 second to 1000 seconds and at a working temperature range approximately from 15° C. to 55° C., molding the energy absorbing foam material around a shape to be protected by the energy absorbing foam material; (3) using the molded energy absorbing foam material at a temperature range approximately from 15° C. to 55° C. ; (4) self-recovering the original shape of the energy absorbing foam material without the application of force or heat.

In one aspect of the present invention, the working temperature is 15° C. to 55° C.

In one aspect of the present invention, the yield point of the energy absorbing foam material is approximately from 25 kPa to 0.23 MPa.

### BRIEF DESCRIPTION OF THE DRAWINGS

The disclosure will become more fully understood from the detailed description given herein below for illustration only, and thus not limitative of the disclosure, wherein:

FIG. 1 illustrates the diagram showing the storage modulus of the energy absorbing foam material in the present invention is related to the temperature and frequency.

FIG. 2 illustrates the diagram further showing the Elastic/Loss Modulus and Tan delta of the energy absorbing foam material in the present invention is related to the temperature and frequency.

FIG. 3 shows an energy absorbing foam material employed in the helmet in one embodiment of the present invention.

FIG. 4 schematically depicts a shape memory foam can easily be deformed to a new shape under constant stress in a slow way.

FIG. 5 shows the yield point of the foam materials during compression.

### DEFINITIONS

The terms “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a concentration range of “about 0.1% to about 5%” should be interpreted to include not only the explicitly recited concentration of about 0.1 wt. % to about 5 wt. %, but also the individual concentrations (e.g., 1%, 2%, 3%, and 4%) and the sub-ranges (e.g., 0.1% to 0.5%, 1.1% to 2.2%, and 3.3% to 4.4%) within the indicated range.

The term “shape memory polymer foam” used herein, refers to a unique class of polymers or materials which is fabricated through foaming process and exhibit the ability to fix at a prior state shape or a non-impact resistant configuration with a lower elastic modulus and then shift to a temporary state or an impact resistant configuration by an external stimulus. Examples of shape memory polymers foam used in the present invention include, but are not limited to polyurethane foam, polystyrene foam, silicon rubber foam, polyvinyl chloride foam, ethylene-vinyl acetate foam, and polyester block co-polymer foam.

### DETAILED DESCRIPTION

The following disclosure provides many different embodiments or examples for implementing different features of the provided subject matter. Specific examples of components and arrangements are described below. Certainly, these descriptions are merely examples and are not intended to be limiting. The embodiments of the present disclosure are described in detail below. However, it should be understood that many applicable concepts provided by the present disclosure may be implemented in a plurality of specific environments. The described specific embodiments are only illustrative and do not limit the scope of the present disclosure.

According to the present invention, there is provided an energy absorbing foam material which is in a non-impact resistant configuration in a long force-application time, and in an impact resistant configuration in a short force-application time. The long force-application time is approximately from 0.1 second to 1000 seconds, and the short force-application time is approximately below 0.1 second. Under the short force-application time, the elastic modulus of the energy absorbing foam material is approximately 10 times than that under the long force-application time, indicating the energy absorbing foam material is suitable to offer a degree of impact protection. The transition from low elastic modulus (non-impact configuration) to high elastic modulus (impact configuration) is rapid without time delay. In one embodiment of the present invention, the energy absorbing foam material is flexible and resilient to various kinds of loading, for example, but not limited to, compression, tension, shear, and torsion. Further, it has the ability to adapt the geometry figures/shapes of what it is designed and maintain intimate contact to the protected subject. This is very crucial for being as a protecting material because the induced damage is related to the maximum force resulting from the impact divided by the area over which the force is applied. The energy absorbing foam material in the present invention is able to absorb the impact energy and reduce the force in the area where the force is applied, therefore the stress and pressure of the impact is significantly decreased. In one embodiment of the present invention, the energy absorbing foam material contacted intimately and was able to delineate the shape of the subject while applying forces in the corresponding ends at approximately 10 seconds.

The energy absorbing foam material disclosed in the present invention comprises at least one shape memory polymer foam and additives. The shape memory polymer foam, for example, but not limited to polyurethane foam, polystyrene foam, silicon rubber foam, polyvinyl chloride foam, ethylene-vinyl acetate foam, and polyester block co-polymer foam. Further, the amount of shape memory polymer foam is at least approximately 50 with respect to the weight thereof. The additives, for example, but not limited to anti-oxidant, flame retardant, inorganic fillers and the amounts of additives is less than approximately 50% with respect to the weight thereof.

The foam material provided in the present invention is in a closed cell foam or an open cell foam. The cell includes, for example, but not limited to gas, vapor or blowing agents. The gas for example, is nitrogen or carbon dioxide. Usually the gas or vapor would disperse uniformly in the material or non-uniformly according the applications in some embodiments. The presence of gas or vapor within the foam material not only reduce the overall density of the foam material but also provide cushion in the foam material due to the pneumatic effect. These pneumatic damping is crucial for energy absorption and dissipation when the impact suddenly occurs.

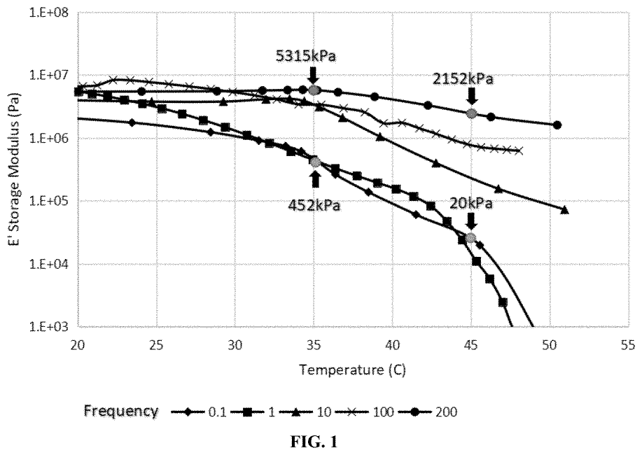

The elastic modulus of the energy absorbing foam material in the present invention is influenced by factors, for example, but not limit to temperature, force-application time, loading, or frequency. Referring to FIG. 1, it showed the elastic modulus of the energy absorbing foam material at the force-application time approximately 0.005 to 0.01 seconds (i.e. with the frequency approximately from 100 to 200 Hz) is approximately 10 times larger than that at the force-application time approximately 1 to 10 seconds (i.e. with the frequency approximately from 0.1 to 1 Hz) at 35° C. Further, the difference of elastic modulus increased to approximately 100 times at the temperature over 45° C.

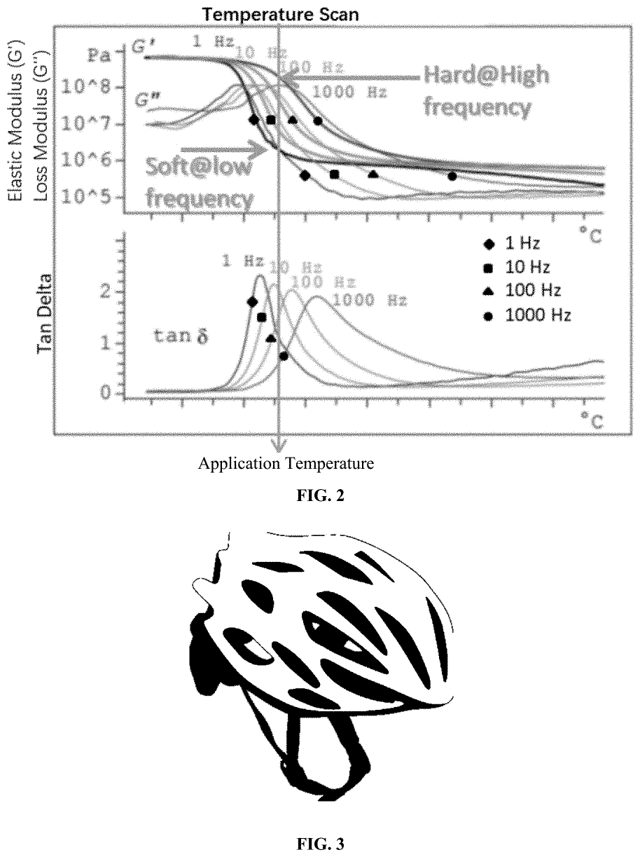

As shown in FIG. 2, the glass transition temperature of the energy absorbing foam material in the present invention is equal to or lower than the application temperature (such as 35° C.) at the force-application time approximately 0.1 to 1 seconds (i.e. with the frequency approximately from 1 to 10 Hz), which indicates the foam material is in rubbery state and behaves soft and flexible. Furthermore, the glass transition temperature of the energy absorbing foam material is higher than the application temperature at the force-application time approximately 0.01 to 0.001 seconds (i.e. with the frequency approximately from 100 to 1000 Hz), which indicates the foam material is in glassy state and behaves hard and rigid.

The energy absorbing foam material in the present invention is able to be employed in many applications, for example, but not limit to protective pads, protective layers, or any other objects with which the subjects might come into a serious impact. As shown in FIG. 3, the foam material provided in the present invention is utilized as protective pad in the helmet. When the subject put the helmet on, the protective pad is able to fit the profile and contact intimately to the head of the subject. If the helmet is taken off, the recovery time of the protective pad from head profile configuration, i.e. deformed configuration to the original configuration would take several hours. During wearing the helmet, if some impacts accidentally happen, the protective pad responses from non-impact resistant configuration to impact resistant configuration in a short time window to spread the impact force, then protect the wearer's head. Further, the final properties of the foam material described herein, such as elastic modulus, glass transition temperature, yield point and yield strength are controlled carefully by the foam composition for various applications.

### EXAMPLES

### Example 1

Reference is made to FIG. 1. In this embodiment, the present foam is selected from shape memory polyurethane foam, which is produced by mixing 100 g polyol (M.W.=800 g/mol, Fₙ=3), 1.6 g water, 1.2 g surfactant TEGOSTAB® B 8002 from Evonik, 0.3 g A33 catalyst, 0.15 g stannous octoate catalyst, and 70 g liquid MDI-50 which is a mixture of 50% 4 4′-methylenebis(phenyl isocyanate) and 50% 2,4-methylenebis(phenyl isocyanate).

In this example, the Dynamic Mechanical Analysis test was performed under 200 Hz (equal to the force application time of 0.005 s) and 0.1 Hz (equal to the force application time of 10 s) in compression mold with the heating scan from 20° C. to 50° C. at 3° C. per minute. At 35° C., the elastic modulus is about 5.3×10⁶ Pa at 200 Hz and 4.5×10⁵ Pa at 0.1 Hz respectively. Thus the elastic modulus ratio between 200 Hz and 0.1 Hz of the present foam material is about 12 at 35° C. at 45° C., the elastic modulus is about 2.2×10⁶ Pa at 200 Hz and 2×10⁴ Pa at 0.1 Hz respectively. Thus the elastic modulus ratio between 200 Hz and 0.1 Hz of the present foam material is about 110 at 45° C. The foam shows a first glass transition temperature equal to or lower than a working temperature (35˜45° C.) in the first force-application time (0.1 Hz or 10 s), and a second glass transition temperature higher than a working temperature (35˜45° C.) in the second force-application time (200 Hz or 0.005 s)

### Example 2

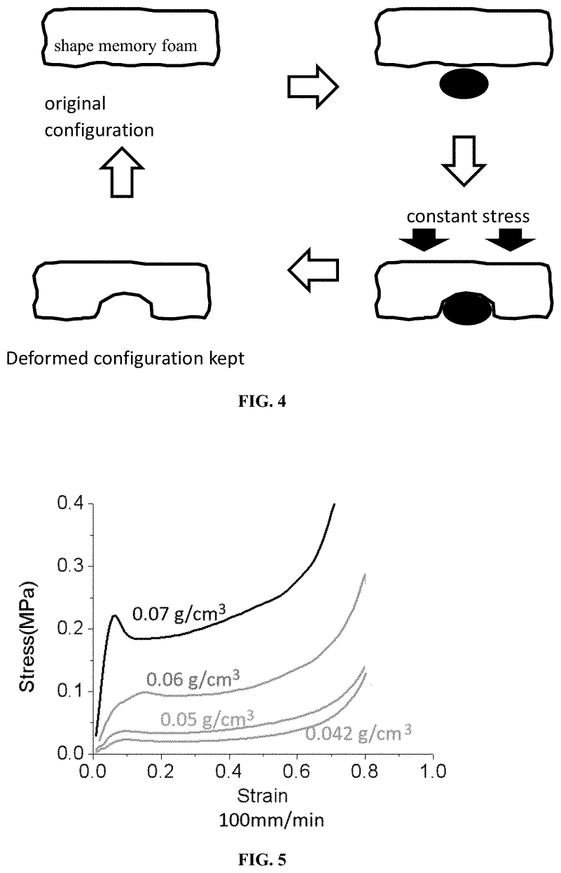

Referring to FIG. 4, the disclosed shape memory foam of Example 1 can easily be deformed to a new shape under constant stress (arrowhead in FIG. 4) in a slow way. The new shape can be “memorized” temporarily. Moreover, if the constant stress is removed, then it would take the shape memory foam several hours to recover from the deformed configuration to the original configuration.

### Example 3

Referring to FIG. 5, in this embodiment, the present foam is selected from shape memory polyurethane foam, which is produced by mixing 100 g polyol(M.W.=800 g/mol, Fₙ=3), 1.6 g-3 g water, 1.2 g surfactant TEGOSTAB® B 8002 from Evonik, 0.3 g A33 catalyst, 0.15 g stannous octoate catalyst, and 70 g liquid MDI-50 which is a mixture of 50% 4 4′-methylenebis(phenyl isocyanate) and 50% 2,4-methylenebis(phenyl isocyanate). By adjusting the content of blowing agent (water) from 1.6 g to 3 g, the density of foam can be changed from 0.07 g/cm³ to 0.04 g/cm³. The yield point of the foam material is approximately from 25 kPa to 0.23 MPa. By adjusting the foam material and density, the yield point can be adjusted according to the specific application. Once the yield point is passed, some deformation will be easily made.

### Comparative Example 1

In this embodiment, the present foam is selected from a high resilience flexible foam, which is produced by mixing 100 g polyol(M.W.=5000 g/mol, Fₙ=3), 1.6 g water, 1.2 g surfactant TEGOSTAB® B 8002 from Evonik, 0.3 g A33 catalyst, 0.15 g stannous octoate catalyst, and 30 g liquid MDI-50 which is a mixture of 50% 4 4′-methylenebis(phenyl isocyanate) and 50% 2,4-methylenebis(phenyl isocyanate). In this example, the Dynamic Mechanical Analysis test was performed under 200 Hz (equal to the force application time of 0.005 s) and 0.1 Hz(equal to the force application time of 10 s) in compression mold with the heating scan from 20° C. to 50° C. at 3° C. per minute. At 35° C. the elastic modulus is about 3×10⁴ Pa and 2.5×10⁴ Pa at 200 Hz and 0.1 Hz respectively. Thus the elastic modulus ratio between 200 Hz and 0.1 Hz of this foam material is only 1.2 at 35° C. The foam shows a glass transition temperature lower than the working temperature (35° C.) both in the first force-application time (0.1 Hz or 10 s) and in the second force-application time (200 Hz or 0.005 s).

### Comparative Example 2

In this embodiment, the present foam is selected from a rigid foam, which is produced by mixing 100 g polyol(M.W.=500 g/mol, Fₙ=3), 1.6 g water, 1.2 g surfactant TEGOSTAB® B 8002 from Evonik, 0.3 g A33 catalyst, 0.15 g stannous octoate catalyst, and 99 g liquid MDI-50 which is a mixture of 50% 4 4′-methylenebis(phenyl isocyanate) and 50% 2,4-methylenebis(phenyl isocyanate). In this example, the Dynamic Mechanical Analysis test was performed under 200 Hz (equal to the force application time of 0.005 s) and 0.1 Hz (equal to the force application time of 10 s) in compression mold with the heating scan from 20° C. to 50° C. at 3° C. per minute. At 35° C., the elastic modulus is about 7.7×10⁶ Pa and 7.2×10⁶ Pa at 200 Hz and 0.1 Hz respectively. Thus the elastic modulus ratio between 200 Hz and 0.1 Hz of this foam material is only 1.1 at 35° C. The foam shows a glass transition temperature higher than the working temperature (35° C.) both in the first force-application time (0.1 Hz or 10 s) and in the second force-application time (200 Hz or 0.005 s).

1. An energy absorbing foam material comprising:
at least one shape memory polymer foam comprising a non-impact resistant configuration in a first force-application time, an impact resistant configuration in a second force-application time at a working temperature, a first glass transition temperature equal to or lower than a working temperature in the first force-application time, and a second glass transition temperature higher than a working temperature in the second force-application time;
wherein the non-impact resistant configuration comprises a deformed configuration and an original configuration;
wherein a second elastic modulus of the shape memory polymer foam in the second force-application time is at least 10 times than a first elastic modulus of the shape memory polymer form in the first force-application time at the working temperature;
wherein the first force-application time is approximately from 0.1 second to 1000 seconds;
wherein the second force-application time is approximately below 0.1 second.

2. The energy absorbing foam material of claim 1, wherein the at least one shape memory polymer foam is selected from one or more of polyurethane foam, polystyrene foam, silicone rubber foam, polyvinyl chloride foam, ethylene-vinyl acetate foam, and polyester block co-polymer foam.

3. The energy absorbing foam material of claim 1, wherein the working temperature is approximately from 15 to 55° C.

4. The energy absorbing foam material of claim 1, wherein the yield point of the shape memory foam is approximately from 0.5 kPa to 1 MPa.

5. The energy absorbing foam material of claim 1, wherein the shape memory polymer foam is selected from polyurethane foam.

6. An impact-resistant article comprising the energy absorbing foam material of claim 1.

7. A method of molding the energy absorbing foam material of claim 1, comprising:
providing the energy absorbing foam material having an original shape;
at a force-application time more than approximately 0.1 second to 1000 seconds and at a working temperature range approximately from 15 to 55° C., molding the energy absorbing foam material around a shape to be protected by the energy absorbing foam material;
using the molded energy absorbing foam material at a temperature range approximately from 15° C. to 55° C.;
self-recovering the original shape of the energy absorbing foam material without the application of force or heat.

8. The method of molding the energy absorbing foam material of claim 7, wherein the working temperature is 15° C. to 55° C.

9. The method of molding the energy absorbing foam material of claim 7, wherein the yield point of the energy absorbing foam material is approximately from 25 kPa to 0.23 MPa.
